(19) United States
(12) Patent Application Publication
(10) Pub. No.: US 2012/0198739 A1
(43) Pub. Date: Aug. 9, 2012

(54) ROTATING PANEL DISPLAY

(75) Inventors: PATRICIA A. VENETUCCI, Hawthorn Woods, IL (US); William CARTER, Dyer, IN (US)

(73) Assignee: Florida Plastics International, Inc.

(21) Appl. No.: 13/047,167

(22) Filed: Mar. 14, 2011

Related U.S. Application Data
(60) Provisional application No. 61/440,440, filed on Feb. 8, 2011.

(51) Int. Cl. G09F 11/02; G09F 11/10; G09F 19/00; G09F 13/00

(52) U.S. Cl. 40/470; 40/502

(57) ABSTRACT

A rotating panel display includes a rotating panel element, a base structure that is connected to the rotating panel element, and a control system for rotational control of the rotating panel element. The rotating panel element includes a frame having at least one display side, an internal light source, and at least one transparent display surface on the display side. The frame rotates about an axis of the rotating panel element. The control system includes a position indicator system to provide position information to control the distance of rotation of the frame. The position indicator system includes fixed structures positioned internally in the frame which do not rotate with the frame and frame structures connected to the frame which rotate with the frame. The fixed structures and frame structures periodically interacting with one another as the frame rotates to cause position information to be communicated to the control system.

The present invention claims priority on U.S. Provisional Patent Application Ser. No. 61/440,440 filed on Feb. 8, 2011, which is fully incorporated herein.

The present invention is directed to display systems, and more particularly to a multi-panel display system for use in advertising displays, menu displays and the like.

### BACKGROUND OF THE INVENTION

The use of multi-panel and/or multi-sided signs have long been used to convey various types of information. These signs are commonly used as restaurant menus, drive-through menus, advertising displays, and the like. Non-limiting examples of such signs are disclosed in U.S. Pat. Nos. 7,428,791; 7,174,663; 6,843,011; 6,434,868; 6,295,882; 6,065,232; 5,416,996; and 4,381,616; and United States Patent Publication No. 2008/0236005, all of which are incorporated herein by reference. These signs include panels that have two or more sides, and are designed to rotate so as to convey more than one type of information.

Although multi-panel signs have long been used, problems remain with such signs as to simplicity of properly operating multiple panels and the proper orientation of the panels relative to one another after one or more panels has been rotated. The present invention is directed to an improved multi-panel sign which addresses the past problems of past multi-panel signs.

### SUMMARY OF THE INVENTION

The present invention is directed to a rotating panel display, and more particularly to a rotating multi-panel display. The rotating panel display can be used to convey various types of information such as, but not limited to, advertising material, food menus, etc.

In one non-limiting aspect of the present invention, there is provided a rotating panel display that includes at least one rotating display panel or element. The number of rotating panel elements is non-limiting. Generally, the rotating panel display of the present invention includes 1-10 rotating panel elements. In one non-limiting embodiment of the invention, each rotating panel element includes 1-4 display sides when the rotating menu display includes two or more rotating panel elements. In one non-limiting configuration of this embodiment, each rotating panel element includes 2-3 display sides when the rotating menu display includes two or more rotating panel elements.

In another and/or alternative non-limiting aspect of the present invention, each of the rotating panel elements includes a frame. The frame can be formed of various materials (e.g., metal, plastic, ceramic, composite materials, fiber reinforced materials, wood, glass, etc.). The shape, size and height of the frame is non-limiting. Generally, when two or more rotating panel elements are part of the rotating panel display, the shape and size of the frames are generally the same; however, this is not required. The frame includes an interior cavity or section that houses one or more components of the rotating panel elements (e.g., light source, power source, drive motor, gearing arrangement, informational material to be displayed, rotational control systems, etc.). The frame is configured and designed such that all of the frame or a majority of the frame can rotate about a longitudinal axis of the rotating panel element. As can be appreciate, the frame can be also or alternatively configured and designed such that a portion or all of the frame can rotate about an axis that is transverse to the longitudinal axis of the rotating panel element and/or about an some other axis of the rotating panel element; however, this is not required. The frame is designed to have one or more display sides wherein advertising, marketing, informational literature, etc. can be attached and/or displayed. One or more of the display sides can include a transparent or semi-transparent material (e.g., glass panel, plastic panel, etc.) that are mounted to and/or supported by the frame. In such an arrangement, the frame supports one or more pieces of transparent or semi-transparent material and the advertising, marketing, informational literature, etc. is then positioned behind and/or in front of the transparent or semi-transparent material. As can be appreciated, the advertising, marketing, informational literature, etc. can be printed on the front and/or back face or the transparent or semi-transparent material; however, this is not required. As also can be appreciated, the one or more display sides can include an electronic display screen (e.g., CRT, LED, LCD, DLP, Plasma. etc.); however, this is not required. The frame can include one or more access doors that enable a user to access the interior of the frame. The access door can be used to change out or alter the advertising, marketing, informational literature, etc. one or more display sides of the frame, replace or repair the frame and/or one or more components in the frame, etc. The one or more access doors can include a latch and/or locking mechanism to control or limit access to the interior of the frame, however, this is not required.

In still another and/or alternative non-limiting aspect of the present invention, the frame can be designed to accept a large array of sizes of printed graphic and/or electronic graphics (i.e., electronic displays) for one or more of the display sides of the frame; however, this is not required. The size and shape of printed graphics, graphics panels, graphics sheets, etc. can vary widely. The size and shape can be such that one or more of the printed graphics and/or electronic graphics on each display side of a frame a) completely or substantially fills the complete display side of a frame, b) fills only a portion (e.g., 80%, 75%, 50%, 25%, 10%, etc.) of the display side of the frame. The shape of the one or more of the printed graphics and/or electronic graphics on each display side of a frame can be polygonal (e.g., triangular, square, rectangular, rhomboidal, pentagonal, etc.), circular, oval, etc. One or more of the display sides of the frame can include an universal mounting system that can be used to mount one or more different sized and/or shaped printed graphics and/or electronic graphics on the display side. In one non-limiting embodiment of the invention, the universal mounting system includes a plurality of stops that be used bypassed or used so as to mount graphic that are 100% the display size, 50% the display size, 33% the display size, and 25% the display size. As can be appreciated, the universal mounting system can be configured to mount a smaller combination of graphic sizes (e.g., only 100% and 50%, only 100%, 50% and 25%, etc.) and/or include mounting arrangements for other sizes (e.g., 10% the display size, etc).

In still yet another and/or alternative non-limiting aspect of the present invention, there is provided a light system for at least one of the rotating display panel or elements that is used to illuminate the advertising, marketing, informational literature, etc. positioned on one or more of the display sides of the frame; however, this is not required. The light system is generally positioned internally in the interior of the frame; however, this is not required. When the rotating display panels or elements include an electronic display screen, the inclusion of the light system may be eliminated since such electronic display screens already include a light source. The light system can be formed of one or more light sources and/or one or more types of light source (e.g., incandescent, LED, plasma, LCD, fluorescent, halogen, xenon, etc.). A separate light source may exist for one or more of the display sides of the rotating panel. The location of the one or more light sources on and/or in the frame is non-limiting. The light system can be arranged on/in the frame such that one or more of the light sources rotates with the frame or remains stationary during the rotation of the frame. In one non-limiting configuration, the light source that is positioned in the interior of the frame is mounted so as remain stationary while the frame rotates about the longitudinal axis or some other axis of the rotating display panel or element. In one particular non-limiting arrangement, the light source is connected to the support post that extends into the interior of the frame and/or is connected to another structure in the frame that does not rotate with the frame.

In yet another and/or alternative non-limiting aspect of the present invention, the rotating panel display includes abuse structure upon which one or more rotating display panels or elements are mounted; however, this is not required. The size, shape and materials used to form the base structure is non-limiting. In one non-limiting embodiment of the invention, the base structure includes a support post that is connected to the body of the base structure; however, this is not required. The support post is generally mounted to the body of the base structure in a fixed matter such that the support post is rigidly and non-rotatably connected to the body of the base structure; however, this is not required. The frame of a rotating display panel or element can be connected in any manner and/or any location on the support port. The support post can be designed to partially extend into the interior of the frame when the frame is rotatably mounted to the support post; however, this is not required. When a portion of the support post does extend into the interior of the frame, one or more components that are also positioned in the interior of the frame (e.g.,light source, power source, drive motor, gearing arrangement, informational material to be displayed, rotational control systems, etc.) can be partially or fully mounted to the support post; however, this is not required. As can also be appreciated, the support post can fully extend through the fully longitudinal length of the frame so that the top and bottom of the frame can be connected to the support post, and/or the top of the support post can support a structure positioned above the frame (e.g., hood, etc.); however, this is not required.

In still yet another and/or alternative non-limiting aspect of the present invention, the rotating panel display includes a control system to control the rotational movement of the frame of one or more rotating display panels or elements. When the frame includes two or more display sides, it is important to rotate the frame a correct amount about the longitudinal axis or some other axis of the rotating display panel or element so that the display side is facing in the proper direction after being rotated. Also, when more than one rotating display panel or element exists on the rotating panel display, it is important that the sequence for rotating the plurality of frames is correct so that the frames properly rotate to a desired position and/or are not damaged during rotation. One or more components of the control system can be located in the base structure, one or more rotating display panels or elements, and/or in a location remote from the base structure and/or one or more rotating display panels or elements. In one non-limiting embodiment of the invention, the control system includes a main controller that is designed to receive instructions and then send control signals to activate and/or control the rotation of one or more of the rotating display panels or elements. Generally, one main controller is included in the control system; however, this is not required. The main controller can be designed to receive manually sent signals (e.g., an operator presses a button or switch that sends a signal to the main controller) and/or preselected or preprogrammed signs. As can be appreciated, the manner in which signals are sent to the main controller is non-limiting. As can also be appreciated, the signals can be sent by wire, cable etc. and/or wirelessly (e.g, RF, IR, etc.). The control system can be used to control a single display panel or element or a plurality of display panels or elements. When a plurality of display panels or elements are being controlled by the control system, the control system can control rotation of the display panels or elements independently of one another and/or as a group.

In another and/or alternative non-limiting aspect of the present invention, the control system can be designed to control the timing of rotation of a plurality of display panels or elements; however, this is not required. For example, when three or more display panels or elements are lined up on the base support in a generally straight line, the control system controls the timing of rotation of adjacently positioned display panels or elements such that adjacently positioned display panels or elements do not begin rotation at the same time. In one non-limiting embodiment of the invention, each display panel or element can be independently rotated so that the amount and/or timing or rotation of each display panel or element can be initiated and/or controlled by the control system. In another and/or alternative non-limiting embodiment of the invention, when the rotating panel display includes three or more display panels or elements, the, control system can cause any one of the display panels or elements to rotate while the remaining display panels or elements remain in position, or can cause two or more panels to begin rotating so long as an adjacently positioned display panel or element does not also begin rotating at the same time. Such a rotation sequence for multiple display panels or elements results in decrease damage to the display panels or elements when the display panels or elements are positioned closely together.

In still another and/or alternative non-limiting aspect of the present invention, the control system can include a position indicator system to provide position information to the control system as the frame of one or more rotating display panels or elements rotates relative to the base structure; however, this is not required. Many different types and arrangements of position indicator systems can be used. In one non-limiting configuration, the position indicator system includes one or more fixed structures and one or more frame structures. The one or more fixed structures and one or more frame structures are generally positioned internally in one or more of the frames of the display panels or elements; however, this is not required. The fix structures are mounted so as to not rotate with the frame. The frames are mounted so as rotate with the frame. The fixed structures and frame structures are positioned so as to at least periodically interact with one another as the frame rotates about a longitudinal axis or some other axis of the rotating panel element. The interaction of the fixed and frame structures causes a signal to be generated, which signal is used by the control system and/or drive motor to a) allow continued rotation of the frame until at least the next interaction, b) stop rotation of the frame, and/or c) adjust the rotation of the frame (e.g., allow a little further rotation and then stop rotation, reverse the rotation a little and then stop rotation, etc.). In one non-limiting configuration, the one or more fixed structures are mounted internally in the frame of the display panel or element and are connected to the support post or some other structure inside the frame that remains stationary while the frame rotates. Additionally, the one or more frame structures are mounted to the frame so as to rotate with the frame. In another and/or alternative embodiment of the invention, the position indicator system includes one or more detectors selected from the group consisting of a magnetic detector, a light detector, a sound wave detector, a contact detector, and an electromagnetic wave detector. In one particular non-limiting arrangement, one or more of the detectors are magnetic detectors, a contact detector, and/or an electromagnetic wave detectors. In still another and/or alternative embodiment of the invention, at least two of the frame structures have a different configuration and/or placement on the frame so as to enable the position indicator system to determine a rotational position of the rotating panel display or element. In such an arrangement, the frame structures are shaped or positioned in the frame so that when such frame structures interact with the one or more fixed structures, a certain or unique signal is generated for such interaction which is different from at least one other interaction between another frame structure and one or more fixed structures to thereby differentiate the signals being generated by the interaction with different frame structures. In one non-limiting configuration, there are provided first and second fixed structures. In such a configuration two or more of the frame structures are designed to only interact with certain of the fixed structures. For example, if the frame included three frame structures so as to orient a frame with three display sides, then a first frame structure can be designed to only interact with the first fixed structure, a second frame structure can be designed to only interact with the second fixed structure, and a third frame structure can be designed to interact with both the first and second fixed structures. As can be appreciated, this example is non-limiting. As can also be appreciated, many shapes of the fixed structures and/or many different positions of the fixed structures on the frame can be used to achieve such interactions. In yet another and/or alternative embodiment of the invention, the frame includes at least one frame structure for each display side on the frame; however, this is not required.

In yet another and/or alternative non-limiting aspect of the present invention, one or more rotating display panels or elements can be rotated by its own drive motor; however, this is not required. In such an arrangement specific drive motors can be used to control the rotation of specific rotating display panels or elements. In one non-limiting embodiment of the invention, there is provided a drive motor and gear system for each rotating display panels or elements. The drive motor can be positioned on the interior and/or exterior of the frame of the rotating display panels or elements, and/or be positioned on the support member. In one non-limiting arrangement, each of the drive motors is positioned in the interior of the frame of a plurality or all of the rotating display panels or elements. When the drive motor is located in the interior of the frame, the drive motor can be mounted so as to rotate about the longitudinal axis or some other axis of the rotating display panel or element or be mounted so as to be fixed in a location as the frame rotates about the longitudinal axis or some other axis of the rotating display panel or element. In non-limiting configuration, the drive motor is mounted so as to be fixed in a location and to not rotate about the longitudinal axis or some other axis of the rotating display panel or element when the frame rotates about the longitudinal axis or some other axis of the rotating display panel or element. In such a configuration, there can be provided a gear system that provides interaction between the drive motor and the frame to enable the frame to be rotated by the drive motor.

In still yet another and/or alternative non-limiting aspect of the present invention, a top cover can be provided to be placed above the top of the one or more rotating display panels or elements; however, this is not required. The top cover is designed to protect the rotating display panels or elements from damage. In one non-limiting embodiment of the invention, the top cover is shaped to have an upper sloped surface to cause liquid and other debris to flow or move off of the top cover at the rear of the top cover so as to minimize material flowing off of the top cover and onto a display surface that is facing the front of the rotating panel display. The materials used to form the top cover and the shape of the top cover are non-limiting.

In another and/or alternative non-limiting aspect of the present invention, each of the sides of the frame of the rotating display panels or elements can include a locking arrangement that enables a user to open one or more sides of the frame; however, this is not required. The locking arrangement can include a mechanical and/or electronic locking arrangement. In one non-limiting embodiment, each display side of the frame includes a locking arrangement.

In still another and/or alternative non-limiting aspect of the present invention, secondary advertising and/or marketing structures can be connected to a rotating panel display; however, this is not required. These secondary advertising and/or marketing structures can be used to customize the rotating panel display for a particular use. For example, the secondary advertising and/or marketing structures can include, but are not limited to, 1) materials that include the name of a particular establishment (e.g., TACO BELL, MCDONALDS, BURGER KING, SUBWAY, etc.), 2) materials that are visually pleasing (e.g, sun display, flower display, smiley face, rainbow display, various types of advertising and/or marketing slogans, 3) marketing and/or advertising literature (e.g., signage listing daily, monthly or seasonal specials, signage for various types of advertising and/or marketing campaigns, etc.). Such secondary advertising and/or marketing structures on the rotating panel display (e.g., base structure, top cover, one or more rotating panel elements, etc.).

In summary, in one non-limited embodiment of the invention, there is provided a rotating panel display that includes at least one rotating panel element, a base structure upon which the rotating panel element is connected thereto, and a control system for rotational control of the rotating panel. The rotating panel element includes a frame having at least one display side, an internal light source, and at least one transparent display surface on the display side of the frame. The rotating panel element is connected to the base structure to enable the frame to rotate about a longitudinal axis or some other axis of the rotating panel element. The control system includes a position indicator system to provide position information to the control system as the frame of the rotating panel element rotates relative to the base structure. The position indicator system includes at least one fixed structure positioned internally in the frame which does not rotate with the frame. The position indicator system also includes at least one frame structure connected to the frame which rotates with the frame. The at least one fixed structure and the at least one frame structure periodically interacting with one another as the frame rotates about a longitudinal axis or some other axis of the rotating panel element to thereby cause position information to be communicated to the control system and/or drive motor. The position information is at least partially used by the control system and/or drive motor to control the distance of rotation of the frame about a longitudinal axis or some other axis of the rotating panel element. In one non-limiting and optional arrangement, at least a portion of the position indicator system is positioned in an interior of the frame. In another and/or alternative non-limiting and optional arrangement, the position indicator system includes one or more detectors selected from the group consisting of a magnetic detector, a light detector, a sound wave detector, a contact detector, an ultrasonic wave detector, and an electromagnetic wave detector. In another and/or alternative non-limiting and optional arrangement, the frame includes a drive motor positioned in an interior of the frame, and the drive motor causes the frame to rotate about the longitudinal axis or some other axis of the rotating panel element when the control system activates the drive motor. In another and/or alternative non-limiting and optional arrangement, the base structure includes a fixed support post, and the frame of the rotating panel element is rotatably connected to the support post. In another and/or alternative non-limiting and optional arrangement, the drive motor is connected to the support post and is designed to remain in place as the frame rotates about the longitudinal axis or some other axis of the rotating panel element. In another and/or alternative non-limiting and optional arrangement, the drive motor engages a gear system. In another and/or alternative non-limiting and optional arrangement, at least a portion of the gear system is positioned in the interior of the frame and is connected to the frame. In another and/or alternative non-limiting and optional arrangement, at least three rotating panel elements are connected to the base structure. In another and/or alternative non-limiting and optional arrangement, each of the rotating panel elements includes a frame having at least one display side, an internal light source, at least one transparent display surface on the display side of the frame, a drive motor, and a position indicator system. In another and/or alternative non-limiting and optional arrangement, the position indicator system includes three frame structures, and each frame structure corresponds to one of three display sides for one of the display panels. In another and/or alternative non-limiting and optional arrangement, each of the base structures includes a fixed support post, and the frame of the rotating panel element rotatably connected to the support post. In another and/or alternative non-limiting and optional arrangement, the drive motor is connected to the support post and is designed to remain in position as the frame rotates about the longitudinal axis of the rotating panel element. In another and/or alternative non-limiting and optional arrangement, the drive motor engages a gear system, and at least a portion of the gear system is positioned in the interior of the frame. In another and/or alternative non-limiting and optional arrangement, at least a portion of the gear system is connected to the frame. In another and/or alternative non-limiting and optional arrangement, the internal light source in the rotating panel element is connected to the support post and is designed to remain in position as the frame rotates about the longitudinal axis or some other axis of the rotating panel element. In another and/or alternative non-limiting and optional arrangement, a plurality of the frame structures are connected to the frame. In another and/or alternative non-limiting and optional arrangement, at least two of the frame structures have a different configurations or placement on the frame so as to enable the position indicator system to determine a rotational position of the rotating panel element.

In summary, in one non-limited embodiment of the invention, there is provided a method for controlling the display of information on a rotating panel display system. The method includes a) providing a base structure that includes a fixed support post; b) providing a rotating panel element, wherein the rotating panel element includes a frame having a plurality of display sides, a transparent display surface on each one of display sides of the frame, and an internal light source, and wherein the internal light source is optionally positioned in an interior of the frame, and the frame is rotatably connected to the fixed post of the base structure; c) providing a control system for rotational control of the rotating frame of the display panel, wherein the control system includes a position indicator system to provide position information to the control system and/or drive motor as the frame of the rotating panel element rotates relative to the base structure, and wherein the position indicator system optionally includes at least one Used structure optionally positioned internally in the frame and which does not rotate with the frame and also optionally includes at least one frame structure that is optionally connected to the frame which rotates with the frame, and wherein the at least one fixed structure and frame structure at least periodically interact with one another as the frame rotates about a longitudinal axis or some other axis of the rotating panel element; d) providing a drive motor that is designed to cause the frame to rotate about the longitudinal axis or some other axis of the rotating panel element when the control system activates the drive motor, and wherein the position indicator system provides information to the control system and/or the drive motor to cause the drive motor to stop after a certain amount of rotation of the frame about the longitudinal axis or some other axis of the rotating panel element; and e) activating the control system to cause the control system to activate the drive motor and cause the frame to rotate about the longitudinal axis or some other axis of the rotating panel element until the position indicator system generates a signal to the control system and/or the drive motor to cause the drive motor to stop when a desired amount of rotation of the frame about the longitudinal axis or some other axis of the rotating panel element is completed. In one non-limiting and optional arrangement, at least a portion of the position indicator system is positioned in an interior of the frame. In another and/or alternative non-limiting and optional arrangement, the position indicator system includes a detector selected from the group consisting of a magnetic detector, a light detector, a sound wave detector, a contact detector, an ultrasonic wave detector, and an electromagnetic wave detector. In another and/or alternative non-limiting and optional arrangement, the drive motor is positioned in an interior of the frame. In another and/or alternative non-limiting and optional arrangement, the drive motor is mounted such that the drive motor is maintained in a fixed position relative to the support post. In another and/or alternative non-limiting and optional arrangement, the rotating panel display system includes three rotating panel elements. In another and/or alternative non-limiting and optional arrangement, the rotating panel elements are mounted to the base structure. In another and/or alternative non-limiting and optional arrangement, the frame on each of the rotating panel elements are designed so that the frames can rotate independent of one another or rotate together. In another and/or alternative non-limiting and optional arrangement, each of the rotating panel elements have its own drive motor and position indicator system. In another and/or alternative non-limiting and optional arrangement, the control system is designed to control the sequence and amount of rotation of each of the frames for each of the rotating panel elements. In another and/or alternative non-limiting and optional arrangement, the rotating panel element includes three display sides. In another and/or alternative non-limiting and optional arrangement, the internal light source in the rotating panel element is connected to the support post and is designed to remain in position as the frame rotates about the longitudinal axis or some other axis of the rotating panel element. In another and/or alternative non-limiting and optional arrangement, the position indicator system is positioned in an interior of the frame of the rotating panel elements. In another and/or alternative non-limiting and optional arrangement, the position indicator system includes three frame structures, wherein each frame structure corresponds to one of three display sides on the frame. In another and/or alternative non-limiting and optional arrangement, the position indicator system includes a detector that detects a relative position of at least one of the non-rotatable fixed structures to at least one of the frame structures. In another and/or alternative non-limiting and optional arrangement, the drive motor is connected to the support post and is designed to remain in position as the frame rotates about the longitudinal axis or some other axis of the rotating panel element. In another and/or alternative non-limiting and optional arrangement, the drive motor engages a gear system. In another and/or alternative non-limiting and optional arrangement, at least a portion of the gear system is positioned in the interior of the frame. In another and/or alternative non-limiting and optional arrangement, at least a portion of the gear system is connected to the frame. In another and/or alternative non-limiting and optional arrangement, a plurality of the frame structures are connected to the frame, and at least two of the frame structures have a different configuration and/or placement on the frame so as to enable the position indicator system to determine a rotational position of the rotating panel element.

One non-limiting object of the present invention is the provision of an improved rotating panel display.

Another and/or alternative non-limiting object of the present invention is the provision of an improved method for manufacturing and operating a rotating panel display that includes a plurality of rotating display panels or elements.

Still another and/or alternative non-limiting object of the present invention is the provision of a rotating panel display that includes a control system that can control the rotation of one or more rotating display panels or elements.

Yet another and/or alternative non-limiting object of the present invention is the provision of a rotating panel display that includes a drive system that can individually rotate one of a plurality of rotating display panels or elements.

These and other objects and advantages will become apparent to those skilled in the art upon reading and following the description taken together with the accompanying drawings.

### BRIEF DESCRIPTION OF THE DRAWINGS

Reference may now be made to the drawings which illustrate various non-limiting embodiments that the invention may take in physical form and in certain parts and arrangement of parts wherein:

FIG. 1 is a front elevation view of one non-limiting configuration of the rotating panel display that includes four rotating display panels or elements in accordance with the present invention;

FIG. 2 is a rear elevation view of one non-limiting configuration of the rotating panel display in accordance with the present invention;

FIG. 3 is a front plan view of one non-limiting configuration of the rotating panel display in accordance with the present invention;

FIG. 4 is a side view of one non-limiting configuration of the rotating panel display in accordance with the present invention;

FIG. 5 is a sectional top view of one non-limiting configuration of the rotating panel display in accordance with the present invention;

FIG. 6 is an enlarged front elevation view of one of the rotating display panels or elements;

FIG. 7 is an enlarged top sectional view of one of the rotating display panels or elements;

FIG. 8 is an enlarged section view of a corner of one of the rotating display panels or elements;

FIG. 9 is a view along lines 9-9 of FIG. 7; and,

FIG. 10 is an enlarged section view of a bottom portion of one of the rotating display panels or elements.

### DETAILED DESCRIPTION OF THE NON-LIMITING EMBODIMENT

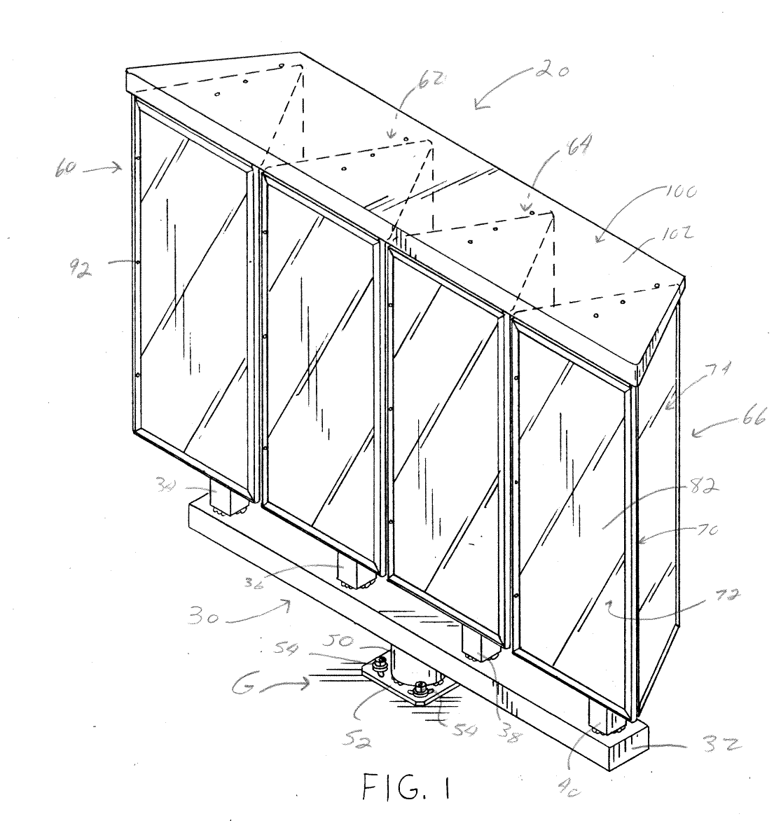

Referring now to the drawings wherein the showings are for the purpose of illustrating preferred embodiments of the invention only and not for the purpose of limiting same, FIGS. 1-10 illustrate one non-limiting configuration of the rotating panel display 20 of the present invention. The rotating panel display is designed to display one or more images. These images can be in the form of printed material and/or electronic media. The rotating panel display is particularly designed for the display of a menu for a drive-through restaurant; however, it can be appreciated that the rotating panel display can be used in many other environments and have many other uses.

The rotating panel display includes a base structure 30. The base structure is designed to support one or more rotating panel displays or elements 60, 62, 64, 66. The base structure can also be used to secure the rotating panel display to a ground surface G; however, this is not required. The base structure can have a variety of shapes and sizes and can be formed of a variety of materials. As illustrated in FIG. 1, base structure 30 includes a main body 32, four support posts, 34, 36, 38, 40, and a base post 50. The four supports are illustrated as being secured to the main body such that the support posts do not rotate relative to the main body. As can be appreciated, other configurations of the rotating panel display can include a base structure having one or more support posts that are mounted to rotate relative to the main body. As illustrated in FIG. 1, the support posts are welded to the top surface of the main body; however, it can be appreciated that the support posts can be connected to other or additional locations on the main body and/or be connected in other or additional ways to the main body (e.g., bolted, integrally formed with the main body, etc.).

The base post 50 is illustrated as being mounted to the ground G. The base post is illustrated as being secured to the main body such that the base post does not rotate relative to the main body. As can be appreciated, other configurations of the rotating panel display can include a base structure having a base post that is mounted to rotated relative to the main body. As illustrated in FIG. 1, the base post is welded to the bottom surface of the main body; however, it can be appreciated that the base post can be connected to other or additional locations on the main body and/or be connected in other or additional ways to the main body (e.g., bolted, integrally formed with the main body, etc.). The bottom of the base post includes a mount flange 52 and a plurality of bolts 54 used to secure the mount flange to ground G. As can be appreciated, base post 50 can be secured to the ground in other or additional ways.

The main body 32 is illustrated as having a generally straight longitudinal axis and having a generally constant cross-sectional shape along the longitudinal length of the main body; however, this is not required. Adjacently positioned supports posts are illustrated as being spaced at a generally equal distance from one another; however, this is not required.

As illustrated in FIGS. 1-3, the rotating panel display includes four rotating panel displays or elements 60, 62, 64, 66. As can be appreciated, the rotating panel display can include less than four rotating panel displays or elements (e.g., 1, 2, 3) or can include more than four rotating panel displays or elements. The four rotating panel displays or elements are illustrated as having generally the same shape and size; however, this is not required. The bottom and top surfaces of adjacently positioned rotating panel displays or elements are illustrated as being positioned at the same height when connected to the base structure; however, this is not required.

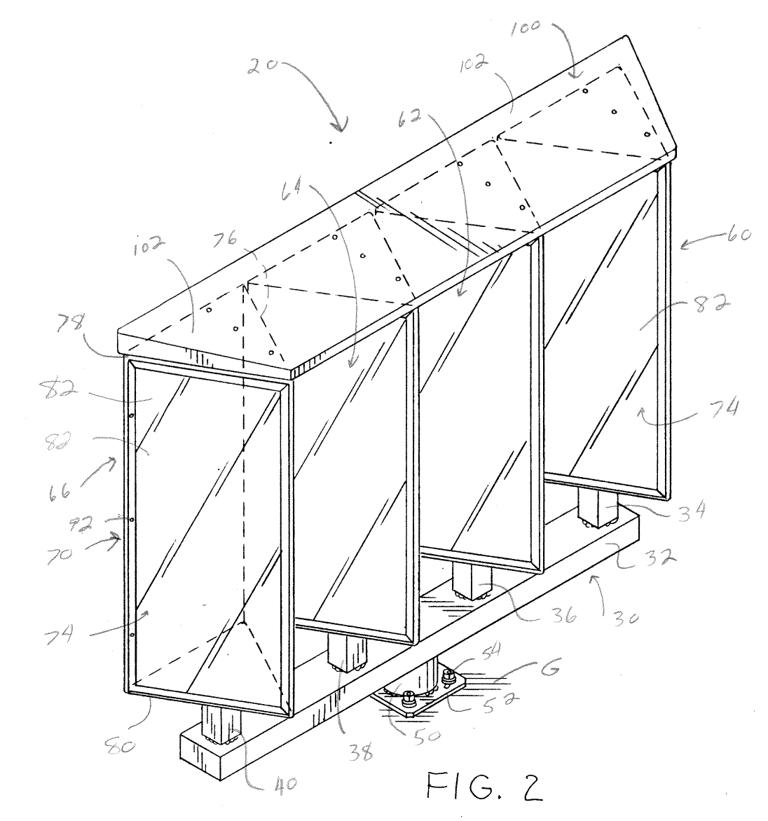

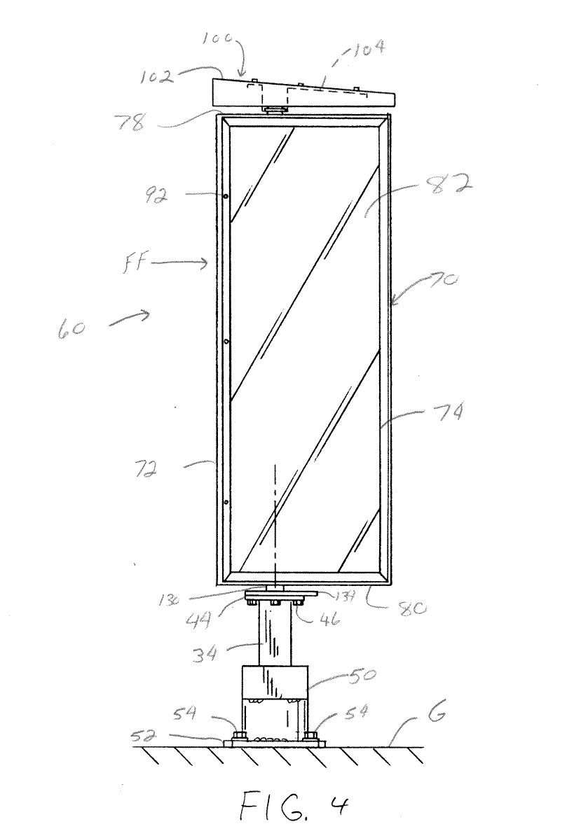

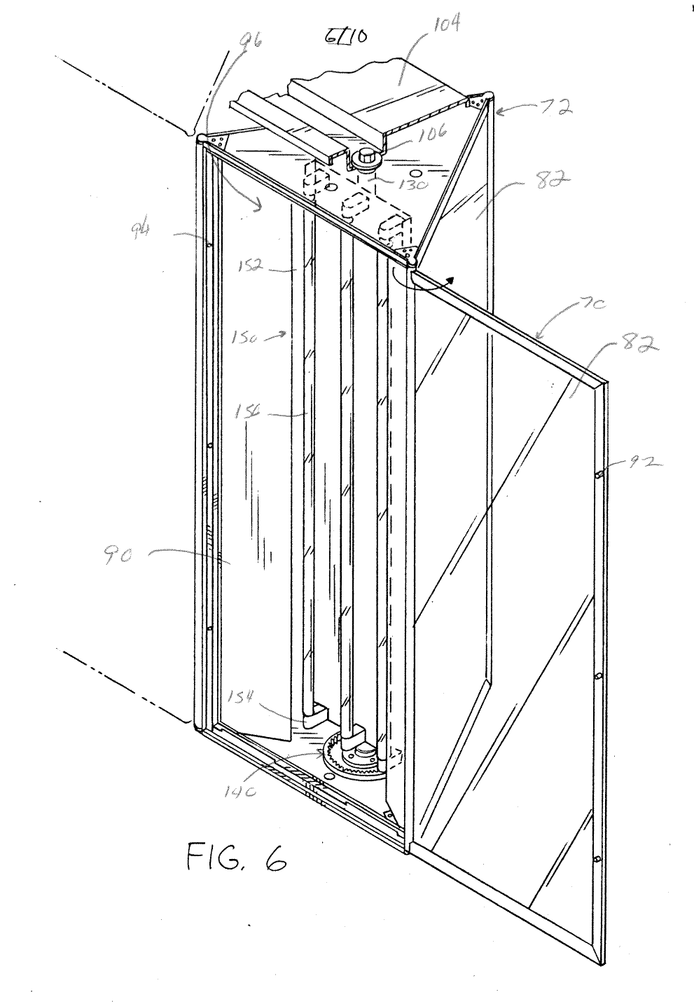

A top cover 100 is illustrated as being connected above the four rotating panel displays or elements. As best illustrated in FIGS. 2 and 4, the top surface 102 of the top cover is sloped downwardly away from the front face FF of the rotating panel display; however, this is not required. The top cover is used to protect the four rotating panel displays or elements from debris and liquid (e.g., rain, ice, snow, etc.). The sloped surface, when used, is designed to direct debris or liquid on the top surface of the top cover to move or flow rearwardly of the front face of the rotating panel display. The bottom of the top cover is illustrated as being spaced above the four rotating panel displays or elements so as to not interfere with the rotation of the four rotating panel displays or elements. The top cover is designed to not rotate with the rotating panel displays or elements. The top cover is illustrated in FIG. 4 to be connected to a cover flange 104 that connected to the top of a rotating panel display or element. FIG. 6 provides a sectional view of the cover flange 104. As can be appreciated, the cover flange can have many other configurations. As can also be appreciated, the top cover can be connected above the rotating panel displays or elements in other or additional ways.

Each of the rotating panel displays or elements include a frame 70 that has three sides 72, 74, 76 and a top side 78 and a bottom side 80. The three sided frame has the general shape of a triangular prism. Each of the sides of the frame include a transparent or semi-transparent panel 82. The complete side or a portion of one or more of the sides of the frames include one or more transparent or semi-transparent panels 82. As illustrated in FIGS. 1-4 and 6, over a majority of each of the three sides of the frames is transparent or semi-transparent panel 82. The transparent or semi-transparent panel 82 can be any type of material (e.g., glass, plastic, etc.). As can be appreciated, a portion, or all of one or more of the transparent or semi-transparent panel can be substituted for an electronic display. As also can be appreciated, the printed material that can be viewed through the transparent or semi-transparent panel can be in the form of a) a printed sheet of material, b) a loop of printed material that can be moved by a roller arrangement or the like so as to change the printed material viewed through the transparent or semi-transparent panel, or c) any other arrangement that can change the form or type of printed material viewed through the transparent or semi-transparent panel.

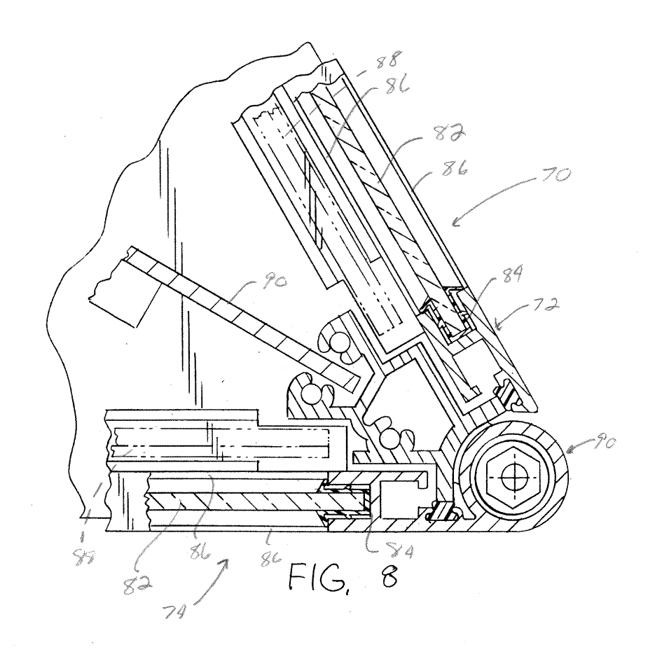

As illustrated in FIG. 6, one or more sides of the frame can be opened so that the interior of the frame can be accessed and/or the material that is being displayed on one or more of the display sizes can be changed out. As illustrated in FIG. 6, one of the sides of the frame is designed so that the side of the frame can swing open as illustrated by the arrow. The frame side can be designed to open in a variety of ways. FIG. 8 illustrates one detail arrangement of the corner of the frame which shows the mounting of the transparent or semi-transparent panel 82 and the manner in which the side of the frame can be designed to swing open. As can be appreciated, other configurations of the frame can be used. For instance, the frame can be used to support multiple transparent or semi-transparent panels that are positioned back to back to one another, or side by side. Also, the side of the frame can be designed to swing upwardly or downwardly, or be easily lifted off the remaining portion of the frame as compared to the swing mount arrangement illustrated in FIGS. 6 and 8.

Referring to the non-limiting arrangement illustrated in FIG. 6, the sectional corner of frame 70 shows a portion of sides 72 and 74. Both sides are designed to swing outwardly. The swing mount 90 for side 74 is illustrated in FIG. 8. Sides 72 an 74 illustrate that a single transparent or semi-transparent panel 82 is mounted in each side. A sealant 84 can be used to secure and seal the transparent or semi-transparent panel to the frame. Protective transparent or semi-transparent screens 86 can optionally be positioned on the front side and/or back side of the transparent or semi-transparent panel. A sealant can be used to facilitate in securing and/or sealing the screen to the frame; however, this is not required. FIG. 6 illustrates in dashed lines an optional second transparent or semi-transparent panel arrangement 88 that can be used. The optional second transparent or semi-transparent panel arrangement can be used to a) sandwich printed material between the first and second transparent or semi-transparent panels, b) increase the rigidity of the frame, and/or c) allow printed material to be removed and/or inserted on a side of a frame while still protecting the internal components of the frame. The corner of the frame can include one or more rigidity flanges 90 to increase the strength and/or rigidity of the frame; however, this is not required. FIG. 6 illustrates that the side of frame can include one or more locking arrangements 92, 94 that enable a user to lock and unlock the side of the frame. As can be appreciated, each of the frame sides that can be opened can include a locking arrangement.

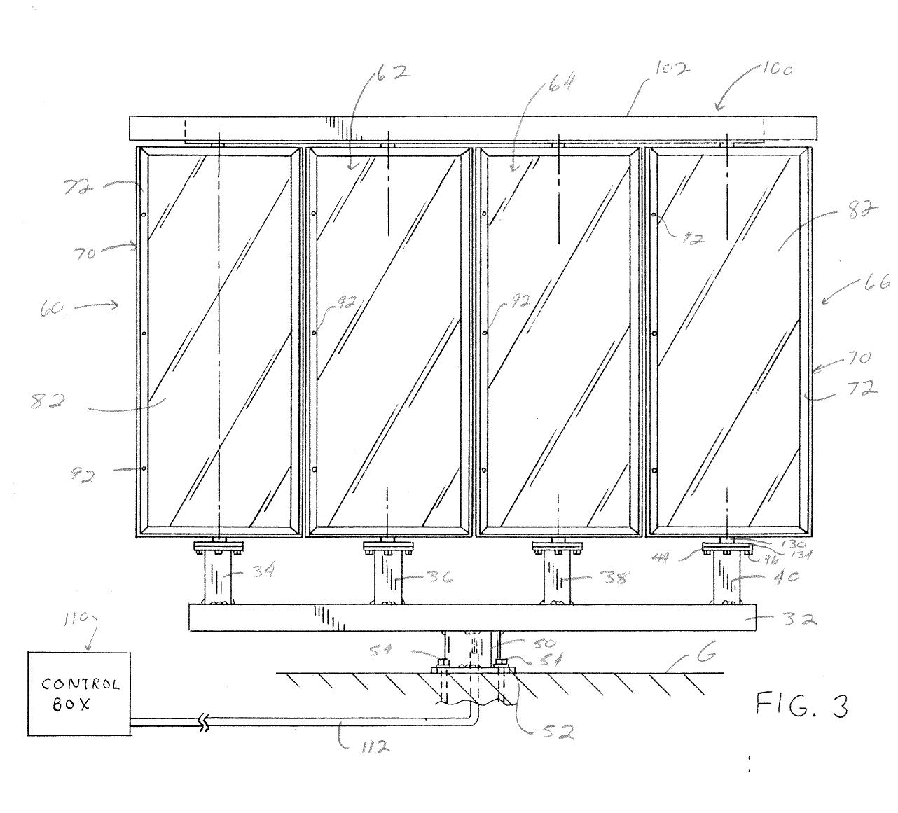

The rotation of each of the rotating panel displays or elements is controlled by a control system. A portion of the control system can be housed in a control box 110 as illustrated in FIG. 3. The location of the control box is non-limiting. The control box is illustrated as being located at some location that is remote from the rotating panel displays or elements and is connected by a cable 112 to the base support and/or one or more rotating panel displays or elements. As can be appreciated, all or a portion of the control box can be located in the base support and/or in one or more of the rotating panel displays or elements. As can also be appreciated, one or more signals can be transmitted wirelessly instead of through cable 112. In one non-limiting arrangement, a set of switches can be located inside a building (e.g., restaurant, merchandise store, etc.), not shown, and signals from the selection of one or more switches can be used to send signals by wire or cable and/or wirelessly to the control box. In one specific arrangement, there can be a breakfast switch, a lunch switch, a dinner switch and a late night dinner switch. The selection of a certain switch will cause one or more of the rotating panel displays or elements to rotate so that the desired menu information on a certain display side of one or more of the rotating panel displays or elements is facing frontwardly so as to display the desired information to consumers. As can be appreciated, the control system can include and/or receive programmed signals that cause one or more of the rotating panel displays or elements to rotate during certain programmed time periods.

The control system can include various circuits, computer chips and/or other electronic devices to achieve the desired rotational control of the rotating panel displays or elements. As can also be appreciated, the control system can also be used to control the light source and/or light intensity in one or more of the rotating panel displays or elements; however, this is not required. If one or more of the rotating panel displays or elements includes a heat source, the control system can be used to control such heat source; however, this is not required. If one or more rotating panels includes an electronic locking system that locks and/or unlocks one or more sides of the frame, the control system can be used to unlock and/or lock such sides; however, this is not required. If one or more of the rotating panel displays or elements includes one or more electronic displays, the control system can be used to control the operation and/or information displayed on such electronic display; however, this is not required. The control system can be designed to be connected to the internet no as to receive and/or send information via the internet (e.g., receive programing information, receive operation signals, receive updated information for use on electronic display, send status information, send error information, etc.). As can be appreciated, such information can also or alternatively be sent and/or received by direct communication or non-internet communication. As can be appreciated, the control system can perform other functions not mentioned above.

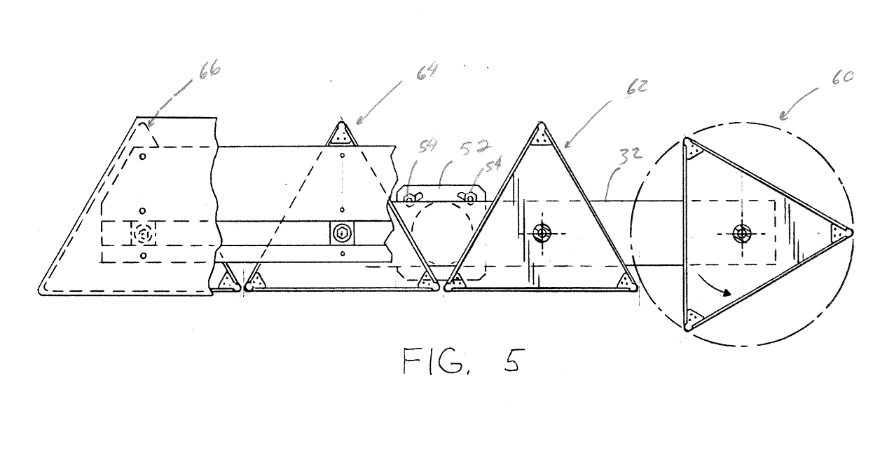

Referring now to FIG. 5, the control system is designed to cause one or more of the frames of the rotating panel displays or elements to rotate about the longitudinal axis of the rotating panel displays or elements. In one non-limiting control arrangement, the control system causes non-adjacently positioned rotating panel displays or elements to simultaneously begin rotating. In such a control arrangement, adjacently positioned rotating panel displays or elements are not started at the same time to rotate. In such a control arrangement, adjacently positioned rotating panel displays or elements are not rotated until 1) the rotating panel display or element that is rotating has completed its rotation, and/or 2) the rotating panel display or element that is rotating has first rotated some predefined amount. Such rotation control of adjacently positioned rotating panel display or element has been found to reduce damage to such rotating panel display or element. As can be appreciated, the control system can create many other or additional rotation sequences for the rotating panel displays or elements. FIG. 5 illustrates the frame of a rotating panel display or element 60 rotating while the frame of adjacently positioned rotating panel display or element 62 remains stationary. As can be appreciated, the frame of rotating panel display or element 64 or 66 could have optionally simultaneously rotated with the frame of rotating panel display or element 60 since such frames are not adjacent to the frame of rotating panel display or element 60.

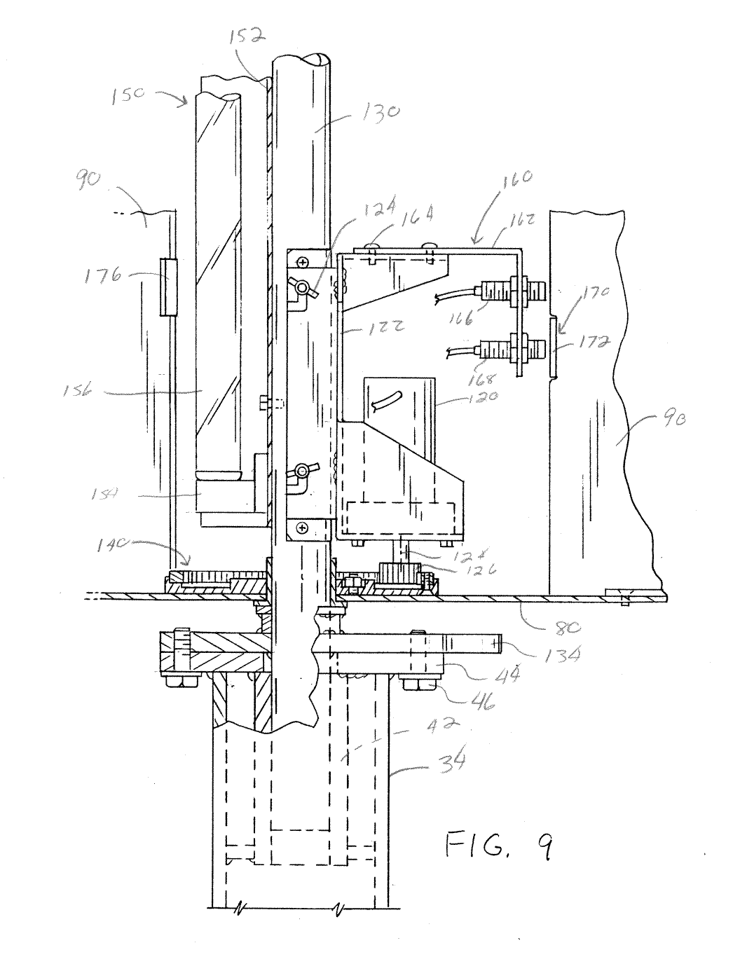

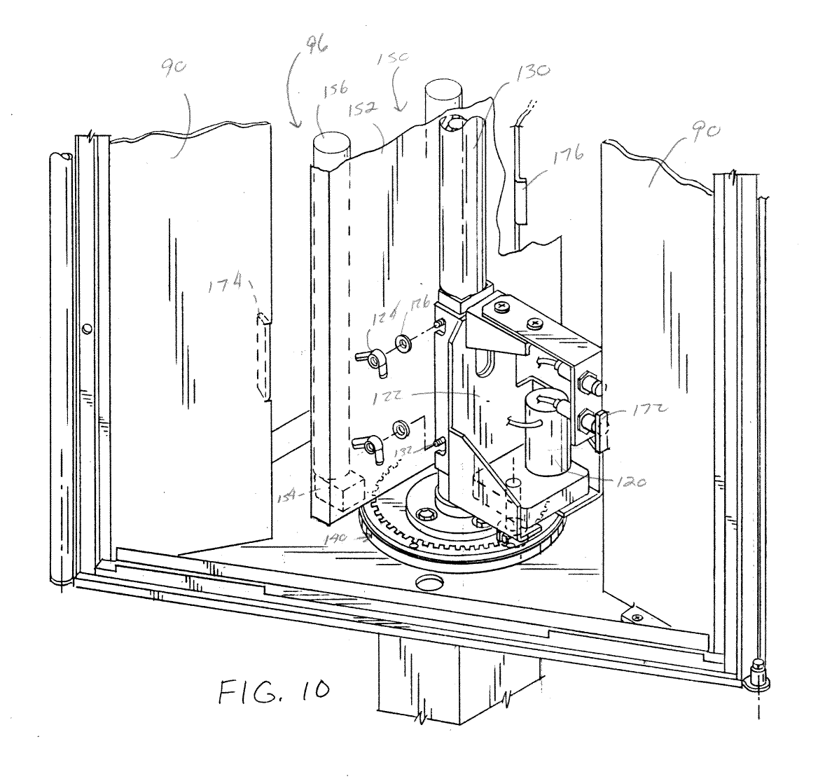

Each of the rotating panel displays or elements are designed to include a drive motor and gear system; however, this is not required. The drive motor 120 and gearing system 130 are best illustrated in FIGS. 6, 7, 9 and 10. The interior cavity 96 of the frames of each of the rotating panel displays or elements generally contain a portion of all of the drive motor and the gear system. As illustrated in FIGS. 9 and 10, the drive motor is fully positioned in the interior cavity of the frame. The drive motor 120 is secured to a motor bracket 122 that is connected to a central post 130. A quick disconnect arrangement can be used to secure the motor bracket to the central post 130; however, this is not required. As illustrated in FIG. 10, two fly nuts 124 and two washers 126 are designed to connect to threaded shafts 132 in the central post 130 to thereby quickly and conveniently connect the motor bracket to the central post. The motor bracket includes two L-shaped slots that easily engage and fit about the threaded shafts. This arrangement is just one non-limiting examples of a quick disconnect and connect arrangement for the motor bracket that can be used.

The central post is designed to extend the fully longitudinal length of the frame for each of the rotating panel displays or elements; however, this is not required. The top of the central post is illustrated as being connected to cover flange 104 by a bolt 106 as illustrated in FIG. 6. As best illustrated in FIG. 9, the bottom of central post 130 is connected to the top of one of the support posts on the base structure. The support post 34 is illustrated as having an internal cavity 42 that receives a bottom portion of the central post. The bottom portion of the central post includes a flange 134 which connects to flange 44 on the top of the support post by bolts 46. As can be appreciated, many other arrangements can be used to connect the central post to the support post. The connection arrangement between the central post and the support post represent the arrangement used to secure the rotating panel displays or elements to the base structure.

The central post 130 is illustrated as being rigidly and non-rotatably connected to the support post. As such, the central post does not rotate as the frame rotates about the longitudinal axis of the rotating panel display or element. The central post can be designed to be positioned along the central longitudinal axis of the rotating panel display or element; however, this is not required. The central post can be considered as an extension of the support post, thus part of the base structure, or can be considered part of the rotating panel display or element. The motor bracket 122 and the drive motor, being mounted to the central post, also do not rotate as the frame rotates about the longitudinal axis of the rotating panel display or element. The drive motor includes a rotatable shaft 124 and a toothed gear 126 connected to the end portion of the rotatable shaft. The toothed gear is designed to engage a toothed surface on the gear system 140. The gear system is connected to the frame of the rotating panel display or element. When the rotatable shaft is turned by the drive motor, the toothed gear 126 engages the teeth on the gear system and causes the frame to rotate about the longitudinal axis of the rotating panel display or element. As can be appreciated, many different arrangements can be used to enable the drive motor to cause the frame to rotate about the longitudinal axis of the rotating panel display or element. As illustrated in FIG. 9, both the gear system and the drive motor are located in the internal cavity of the frame.

Referring again to FIGS. 6, 7, 9 and 10, each rotating panel display or element includes a light source 150. The light source is designed to direct light toward one or more of the transparent or semi-transparent panels 82 so that the printed material can be displayed to a person viewing the rotating panel display. The light source includes a light mount 152 that is connected to the central post 130. The light mount can be connected to the central post in a number of different ways. The light mount is designed to not rotate about the longitudinal axis of the rotating panel display or element while the frame is rotating about the longitudinal axis of the rotating panel display or element. The light mount, like the motor mount, are designed to remain stationary while the frame rotates about the longitudinal axis of the rotating panel display or element; however, it can be appreciated that the light mount could be designed to rotate with the frame. The light mount is illustrated as including sockets 154 for three lights 156. As can be appreciated, the light mount can be designed to mount a greater number or smaller number of lights. The type and shape of the light is non-limiting. The light source is positioned a sufficient distance from the frame so as to not interfere with the rotation of the frame; however, the distance and the illumination intensity is selected to ensure proper illumination of the panel.

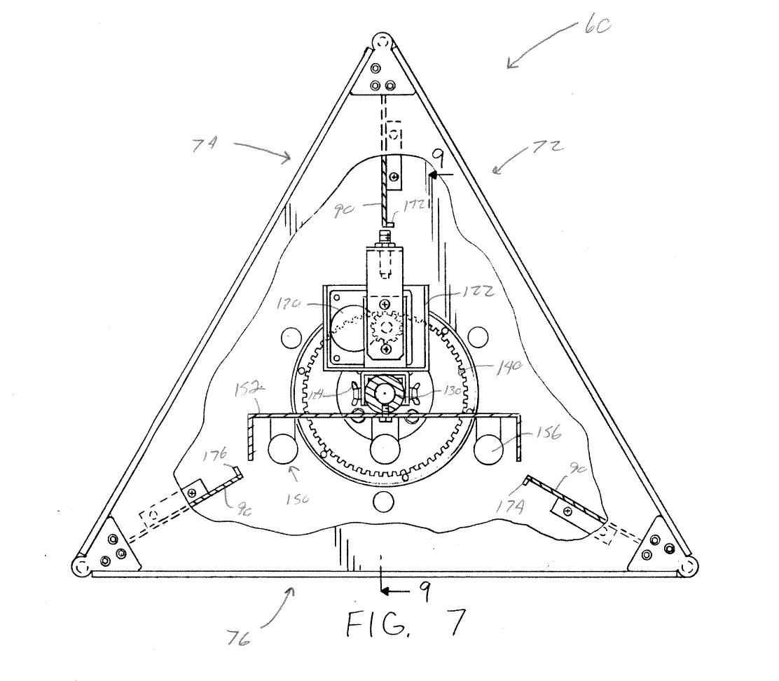

The control system generally includes a position indicator system to provide position information to the control system and/or drive motor regarding the position of the frame as the frame rotates about the longitudinal axis of the rotating panel display or element. The information provided by the position indicator system can be used to stop the drive motor, slow the drive motor, increase the speed of the drive motor and/or reverse the drive motor. The position indicator system is designed to properly orient all of the rotating panel display or element so that the correct display side is facing the front of the rotating panel display and that each rotating panel display or element is properly positioned with respect to one another and the desired display side is properly facing the front of the rotating display panel. Referring now to FIGS. 7, 9 and 10, one non-limiting position indicator system is shown. The position indicator system includes a fixed structure 160 and a frame structure 170. The position indicator system is generally positioned in the interior cavity 96 of the frame; however, this is not required. The fixed structure is designed to not rotate about the longitudinal axis of the rotating panel display or element while the frame is rotating about the longitudinal axis of the rotating panel display or element. The fixed structure 160 includes a support mount 162 that is illustrated as being connected to a portion of the motor mount by connectors 164; however, it can be appreciated that support mount can be connected to other structures (e.g., central post, light mount, etc.). Two detectors 166, 168 are connected to the support mount. The type of detectors are non-limiting (e.g., a magnetic detector, a light detector, a sound wave detector, a contact detector, ultrasonic detector, an electromagnetic wave detector, etc.). In one non-limiting arrangement, detectors 166, 168 are magnetic detectors, contact detectors, or electromagnetic wave detectors. The frame structures 170 are mounted to the frame. As illustrated in FIGS. 9 and 10, frame structures include three contact surfaces, 172, 174, 176, when one contact surface is located on one of the three rigidity flanges 90 located in the interior cavity of the frame. The shape, size and/or position of the three contact surfaces are different so that different detectors and/or different combinations of detectors interact with the different contact surfaces. As illustrated in FIG. 9, contact surface 172 is positioned adjacent to detector 168, but not next to detector 166. As can be appreciated from the position of contact surface 176 illustrated in FIG. 9, the frame rotates so that contact surface pass by the detectors, contact surface 176 is positioned adjacent to detector 166, but not next to detector 168. As can be appreciated from the position of contact surface 174 illustrated in FIG. 10, the frame rotates so that contact surface pass by the detectors, contact surface 174 is positioned adjacent to both detectors 166 and 168. The size of contact surface 174 is larger than contact surfaces 172, 176; however, this is not required. The detectors are designed to generate a signal when one of the contact surfaces is periodically positioned within a certain distance of the detector as the frame rotates about a longitudinal axis of the rotating panel display or element. Such an arrangement can be used to provide information to the control system so that the control system can determine which display side of the frame of a particular rotating panel display or element is facing the front face FF of the rotating panel display. Such an arrangement can also or alternatively be used to terminate the operation of the drive motor to stop the rotation of the frame.

It will thus be seen that the objects set forth above, among those made apparent from the preceding description, are efficiently attained, and since certain changes may be made in the constructions set forth without departing from the spirit and scope of the invention, it is intended that all matter contained in the above description and shown in the accompanying drawings shall be interpreted as illustrative and not in a limiting sense. The invention has been described with reference to preferred and alternate embodiments. Modifications and alterations will become apparent to those skilled in the art upon reading and understanding the detailed discussion of the invention provided herein. This invention is intended to include all such modifications and alterations insofar as they come within the scope of the present invention. It is also to be understood that the following claims are intended to cover all of the generic and specific features of the invention herein described and all statements of the scope of the invention, which, as a matter of language, might be said to fall therebetween.

What is claimed is:

1. A rotating panel display comprising at least one rotating panel element, a base structure upon which said rotating panel element is connected thereto, and a control system for rotational control of said rotating panel, said rotating panel element including a frame having at least one display side, an internal light source, and at least one transparent display surface on said display side of said frame, said rotating panel element is connected to said base structure to enable said frame to rotate about an axis of said rotating panel element, said control system including a position indicator system to provide position information to said control system as said frame of said rotating panel element rotates relative to said base structure, said position indicator system including at least one fixed structure positioned internally in said frame which do not rotate with said frame and at least one frame structure connected to said frame which rotates with said frame, said at least one fixed structure and frame structure periodically interacting with one another as said frame rotates about said axis of said rotating panel element to thereby cause position information to be communicated to said control system, said position information at least partially used by said control system to control the distance of rotation of said frame about said axis of said rotating panel element.

2. The rotating panel display as defined in claim 1, wherein at least a portion of said position indicator system is positioned in an interior of said frame, said position indicator system including a detector selected from the group consisting of a magnetic detector, a light detector, a sound wave detector, a contact detector, and an electromagnetic wave detector.

3. The rotating panel display as defined in claim 1, wherein said frame includes a drive motor positioned in an interior of said frame, said drive motor causing said frame to rotate about said axis of said rotating panel element when said control system activates said drive motor.

4. The rotating panel display as defined in claim 1, wherein said base structure includes a fixed support post, said frame of said rotating panel element rotatably connected to said support post, said drive motor connected to said support post and designed to remain in place as said frame rotates about said axis of said rotating panel element, said drive motor engaging a gear system, at least a portion of said gear system positioned in said interior of said frame and connected to said frame.

5. The rotating panel display as defined in claim 1, wherein at least one of three said rotating panel elements are connected to said base structure, each of said rotating panel elements including a frame having at least one display side, an internal light source, at least one transparent display surface on said display side of said frame, a drive motor, and a position indicator system, each of said position indicator systems including at least one non-rotatable fixed structure positioned internally in said frame and at least one frame structure connected to said frame, said at least one non-rotatable fixed structure and said at least one frame structure periodically interacting with one another as said frame to rotate about said axis of said rotating panel element to thereby cause position information to be communicated to said control system, said position information at least partially used by said control system to control the distance of rotation of said frame about said axis of each of said rotating panel elements.

6. The rotating panel display as defined in claim 5, wherein each of said rotating panel elements includes three display sides, an internal light source for each of said display sides, at least one transparent display surface on each of said display sides, said control system causing non-adjacently positioned rotating panel elements to simultaneously rotate when a plurality of said rotating panel elements are rotated.

7. The rotating panel display as defined in claim 6, wherein said position indicator system is positioned in an interior of said frame of each of said rotating panel elements, said position indicator system including three frame structures, each frame structure corresponding to one of the three display sides for one of said display panels, said position indicator system including a detector that detects a relative position of at least one of said non-rotatable fixed structures to at least one of said frame structures, said detector selected from the group consisting of a magnetic detector, a light detector, a sound wave detector, a contact detector, and an electromagnetic wave detector.

8. The rotating panel display as defined in claim 7, wherein each of said base structure includes a fixed support post, said frame of said rotating panel element rotatably connected to said support post, said drive motor connected to said support post and designed to remain in position as said frame rotates about said axis of said rotating panel element, said drive motor engaging a gear system, at least a portion of said gear system positioned in said interior of said frame and connected to said frame.

9. The rotating panel display as defined in claim 4, wherein said internal light source in said rotating panel element is connected to said support post and designed to remain in position as said frame rotates about said axis of said rotating panel element.

10. The rotating panel display as defined in claim 8, wherein said internal light source in each of said rotating panel elements is connected to said support post and designed to remain in position as said frame rotates about said axis of said rotating panel element.

11. The rotating panel display as defined in claim 1, wherein a plurality of said frame structures are connected to said frame, at least two of said frame structures have a different configuration or placement on said frame so as to enable said position indicator system to determine a rotational position of said rotating panel element.

12. The rotating panel display as defined in claim 10, wherein a plurality of said frame structures are connected to said frame of each of said rotating panel elements, at least two of said frame structures have a different configuration or placement on said frame so as to enable said position indicator system to determine a rotational position of each of said rotating panel elements.

13. A method for controlling the display of information on a rotating panel display system comprising:
a. providing a base structure that includes a fixed support post;
b. providing a rotating panel element, said rotating panel element including a frame having a plurality of display sides, a transparent display surface on each one of display sides of said frame, and an internal light source, said internal light source positioned in an interior of said frame, said frame rotatably connected to said fixed post of said base structure;
c. providing a control system for rotational control of said rotating frame of said display panel, said control system including a position indicator system to provide position information to said control system as said frame of said rotating panel element rotates relative to said base structure, said position indicator system including at least one fixed structure positioned internally in said frame and which does not rotate with said frame and at least one frame structure connected to said frame which rotates with said frame, said at least one fixed structure and frame structure periodically interacting with one another as said frame rotates about an axis of said rotating panel element;
d. providing a drive motor that is designed to cause said frame to rotate about said axis of said rotating panel element when said control system activates said motor, said position indicator system providing information to said control system, said drive motor, or combinations thereof to cause said drive motor to stop after a certain amount of rotation of said frame about said axis of said rotating panel element; and,
e. activating said control system to cause said control system to activate said drive motor and cause said frame to rotate about said axis of said rotating panel element until said position indicator system generates a signal to said control system, said drive motor, or combinations thereof to cause said drive motor to stop when a desired amount of rotation of said frame about said axis of said rotating panel element is completed.

14. The method as defined in claim 13, wherein at least a portion of said position indicator system is positioned in an interior of said frame, said position indicator system including a detector selected from the group consisting of a magnetic detector, a light detector, a sound wave detector, a contact detector, and an electromagnetic wave detector.

15. The method as defined in claim 13, wherein said drive motor is positioned in an interior of said frame and is mounted such that said drive motor is maintained in a fixed position relative to said support post.

16. The method as defined in claim 14, wherein said drive motor is positioned in an interior of said frame and is mounted such that said drive motor is maintained in a fixed position relative to said support post.

17. The method as defined in claim 13, further including the step of providing three rotating panel elements, said rotating panel elements mounted to said base structure, said frame on each of said rotating panel elements designed so that said frames can rotate independent of one another or rotate together, each of said rotating panel elements having its own drive motor and position indicator system, said control system designed to control the sequence and amount of rotation of each of said frames for each of said rotating panel elements.

18. The method as defined in claim 16, further including the step of providing three rotating panel elements, said rotating panel elements mounted to said base structure, said frame on each of said rotating panel elements designed so that said frames can rotate independent of one another or rotate together, each of said rotating panel elements having its own drive motor and position indicator system, said control system designed to control the sequence and amount of rotation of each of said frames for each of said rotating panel elements.

19. The method as defined in claim 13, wherein said rotating panel element includes three display sides, said internal light source in said rotating panel element is connected to said support post and designed to remain in position as said frame rotates about said axis of said rotating panel element.

20. The method as defined in claim 18, wherein said each of rotating panel element includes three display sides, said internal light source in each of said rotating panel elements is connected to said support post and designed to remain in position as said frame rotates about said axis of said rotating panel element.

21. The method as defined in claim 13, wherein said position indicator system is positioned in an interior of said frame of said rotating panel elements, said position indicator system including three frame structures, each frame structure corresponding to one of three display sides on said frame, said position indicator system including a detector that detects a relative position of at least one of said non-rotatable fixed structures to at least one of said frame structures, said detector selected from the group consisting of a magnetic detector, a light detector, a sound wave detector, a contact detector, and an electromagnetic wave detector.

22. The method as defined in claim 20, wherein said position indicator system is positioned in an interior of said frame of said rotating panel elements, said position indicator system including three frame structures, each frame structure corresponding to one of three display sides on said frame, said position indicator system including a detector that detects a relative position of at least one of said non-rotatable fixed structures to at least one of said frame structures, said detector selected from the group consisting of a magnetic detector, a light detector, a sound wave detector, a contact detector, and an electromagnetic wave detector.

23. The method as defined in claim 13, wherein said drive motor is connected to said support post and is designed to remain in position as said frame rotates about said axis of said rotating panel element, said drive motor engaging a gear system, at least a portion of said gear system positioned in said interior of said frame and connected to said frame.

24. The method as defined in claim 22, wherein said drive motor in each of said rotating panel elements is connected to said support post of said rotating panel element and is designed to remain in position as said frame rotates about said axis of said rotating panel element, said drive motor engaging a gear system, at least a portion of said gear system for each of said rotating panel elements is positioned in said interior of said frame and connected to said frame.

25. The method as defined in claim 13, wherein a plurality of said frame structures are connected to said frame, at least two of said frame structures have a different configuration or placement on said frame so as to enable said position indicator system to determine a rotational position of said rotating panel element.

26. The method as defined in claim 24, wherein a plurality of said frame structures are connected to said frame for each of said rotating panel element, at least two of said frame structures on each of said frames having a different configuration or placement on said frame so as to enable said position indicator system to determine a rotational position for each of said rotating panel elements.

27. The method as defined in claims 26, including the step of connecting at least one secondary advertising structure or marketing structure to said rotating panel display system.
